(19) United States
(12) Patent Application Publication
(10) Pub. No.: US 2024/0099533 A1
(43) Pub. Date: Mar. 28, 2024

(54) BOARDING SWEEPER

(71) Applicant: HONDA MOTOR CO., LTD., Tokyo (JP)

(72) Inventor: Masanori ISHIKAWA, Wako-shi (JP)

(21) Appl. No.: 17/952,575

(22) Filed: Sep. 26, 2022

(51) Int. Cl. A47L 9/28; A47L 5/22; A47L 9/00; A47L 9/04; E01H 1/05; H01M 50/204; H01M 50/249

(52) U.S. Cl. CPC A47L 9/2884; A47L 5/22; A47L 9/009; A47L 9/0472; E01H 1/053; H01M 50/204; H01M 50/249; B60L 50/66

(57) ABSTRACT

A boarding sweeper comprises a cleaning working unit capable of executing cleaning work, a seat portion for seating a user, an operation input unit that allows the user to input a driving operation, and a battery holder that detachably holds a battery unit, wherein, when an area on one lateral side with respect to a virtual line passing through in a front-and-rear direction of a vehicle body in plan view is defined as a first area and an area on the other lateral side is defined as a second area, the cleaning working unit, the seat portion, and the operation input unit are disposed in the first area, and the battery holder is disposed in the second area.

### BACKGROUND OF THE INVENTION

### Field of the Invention

The present invention relates to a boarding sweeper.

### Description of the Related Art

Some sweepers are configured to allow a user to board a sweeper main body, and allow the user to execute cleaning work on a road surface or a floor surface while driving and operating the sweeper (see Japanese Patent Laid-Open No. 5-300856). Such a sweeper may also be referred to as a road surface cleaning machine, a floor cleaning machine, or simply a cleaning machine, and may also be referred to as a working machine from other viewpoints.

Some of the sweepers described above include a detachable battery unit to allow the battery unit to be replaced at a desired timing, thereby allowing for a relatively wide cleaning area. In general, in such a sweeper, further contrivance for improving the efficiency of the cleaning work is required.

### SUMMARY OF THE INVENTION

An exemplary object of the present invention is to improve the efficiency of cleaning work by a sweeper.

One of the aspects of the present invention provides a boarding sweeper, comprising a cleaning working unit capable of executing cleaning work, a seat portion for seating a user, an operation input unit that allows the user to input a driving operation, and a battery holder that detachably holds a battery unit, wherein, when an area on one lateral side with respect to a virtual line passing through in a front-and-rear direction of a vehicle body in plan view is defined as a first area and an area on the other lateral side is defined as a second area, the cleaning working unit, the seat portion, and the operation input unit are disposed in the first area, and the battery holder is disposed in the second area.

Further features of the present invention will become apparent from the following description of exemplary embodiments with reference to the attached drawings.

### BRIEF DESCRIPTION OF THE DRAWINGS

FIG. 1 is a perspective view of a structure of a sweeper according to an embodiment;

FIG. 2A is a schematic top view illustrating an example of a configuration of a sweeper;

FIG. 2B is a schematic side view illustrating an example of a configuration of a sweeper;

FIG. 3 is a schematic top view illustrating another example of the configuration of the sweeper; and

FIG. 4 is a schematic diagram illustrating another example of a configuration of a battery holder.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

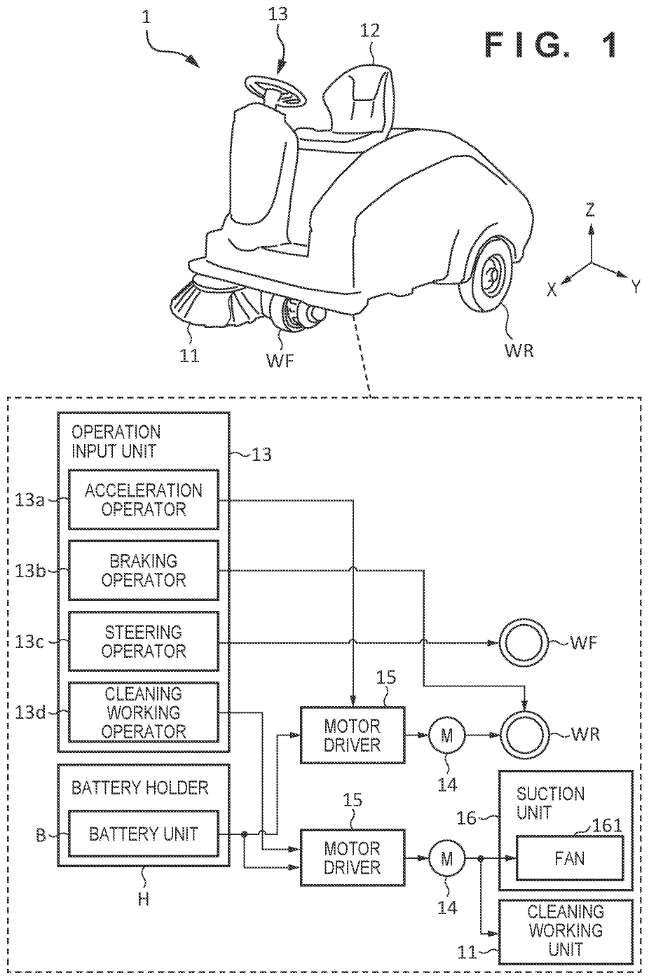

FIG. 1 is a perspective view of a structure of a sweeper 1 according to a first embodiment. In the drawing, an X axis, a Y axis, and a Z axis orthogonal to each other are illustrated in order to facilitate understanding of the structure (the same applies to other drawings described later). The X direction corresponds to a front-and-rear direction of the vehicle body, the Y direction corresponds to a left-right direction of the vehicle body or a vehicle width direction, and the Z direction corresponds to a vertical direction of the vehicle body. In the present specification, terms such as front/rear, left/right (lateral), and up/down refer to relative positional relationships with respect to the vehicle body. For example, terms such as “front” and “front side” correspond to the +X direction, and terms such as “rear” and “rear side” correspond to the −X direction. Similarly, expressions such as the inside of the vehicle body, the outside of the vehicle body (inside and outside of the vehicle), and the like indicate a relative positional relationship with respect to the vehicle body.

The sweeper 1 includes a cleaning working unit 11, a seat portion 12, and an operation input unit 13. The cleaning working unit 11 is configured to perform cleaning work. In the present embodiment, the cleaning working unit 11 is a rotary brush attached to a lower portion of a vehicle body and having substantially a Z axis as a rotation axis, and the cleaning work on the road surface or the floor surface can be realized by the rotation of the rotary brush. Further, the rotary brush may be configured to be movable up and down, and can realize or curtail the cleaning work by approaching or separating from the road surface. Incidentally, the rotary brush main body may be configured to be swingable with respect to the rotation axis, or the rotation axis of the rotary brush may be swingable with respect to the Z direction.

The seat portion 12 is configured such that a user can sit on the seat portion 12, whereby the user can access the operation input unit 13 in a state of being seated on the seat portion 12. Although details will be described later, the operation input unit 13 can input driving operations such as straight traveling, backward traveling, and turning of the sweeper 1, and can also perform operation input for the cleaning working unit 11.

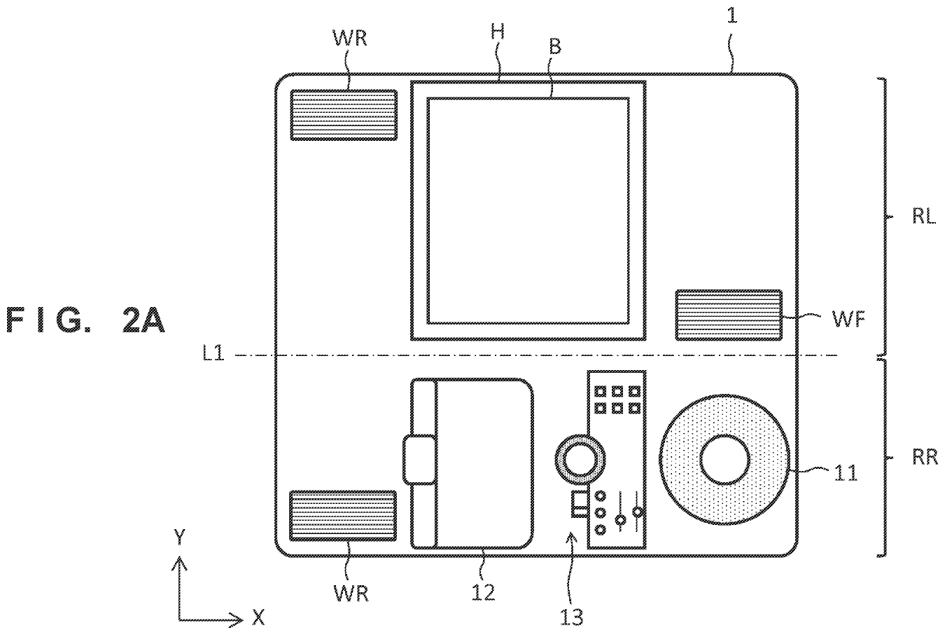

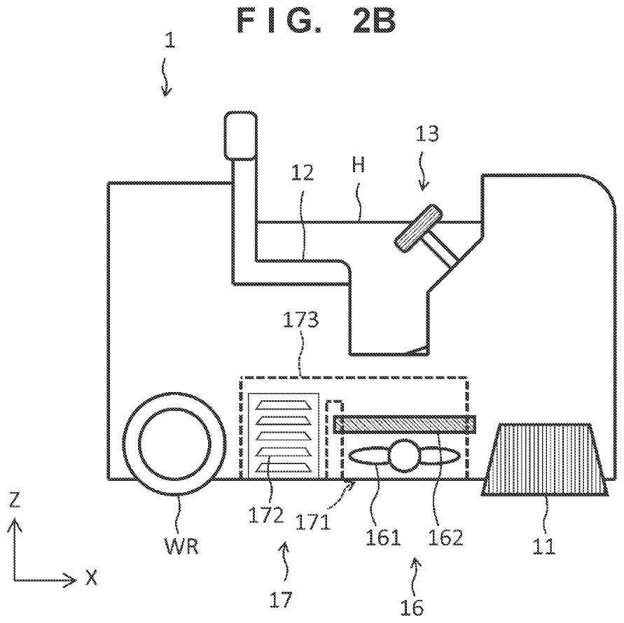

FIGS. 2A and 2B schematically illustrate an example of the configuration of the sweeper 1. FIG. 2A illustrates a configuration example of the sweeper 1 in a plan view, and FIG. 2B illustrates a configuration example of the sweeper 1 in a side view. Hereinafter, a configuration example of the sweeper 1 will be described with reference to FIGS. 1, 2A, and 2B.

In the present embodiment, the sweeper 1 is a three-wheeled vehicle further including a pair of left and right rear wheels WR which are drive wheels and a single front wheel WF which is a steering wheel, and further includes a battery holder H, an electric motor 14, and a motor driver 15. The battery holder H holds the battery unit B in a detachable or insertable/removable manner.

The electric motor 14 is driven and controlled by the motor driver 15 based on the electric power of the battery unit B held by the battery holder H, and generates power (rotation). The power is used to drive other mechanical elements included in the sweeper 1 in addition to the drive of the rear wheel WR, and a plurality of electric motors 14 and a plurality of motor drivers 15 can be provided correspondingly.

The operation input unit 13 includes an acceleration operator 13a, a braking operator 13b, and a steering operator 13c. The user can drive the rear wheel WR using the acceleration operator 13a and the braking operator 13b, and can change the direction of the front wheel WF using the steering operator 13c. In this manner, the user can perform driving operations such as straight traveling, backward traveling, and turning of the sweeper 1. A known operator may be used as each operator. For example, an accelerator pedal or the like may be used for the acceleration operator 13a, a brake pedal or the like may be used for the braking operator 13b, and a steering wheel or the like may be used for the steering operator 13c.

In the present embodiment, the steering operator 13c may be a steering mechanism having the front wheel WF as a steering wheel, and may be configured to be able to change the direction of the front wheel WF via a shaft based on the rotation of the steering wheel. Therefore, the steering operator 13c can have a relatively simple configuration.

The operation input unit 13 further includes a cleaning working operator 13d, and the user can bring the cleaning working unit 11 into the operating state or the dormant state using the cleaning working operator 13d, and change the operation level in the operating state. As the cleaning working operator 13d, a known switch such as a lever type switch or a button type switch may be used.

As illustrated in FIGS. 2A and 2B, the sweeper 1 further includes a suction unit 16 and an air guiding mechanism 17. The suction unit 16 is configured to be capable of executing negative pressure suction, and is provided in the vicinity of the cleaning working unit 11, in the present embodiment, behind the cleaning working unit 11. As a result, foreign matter (dirt, dust, trash, chemicals for cleaning them, and the like) generated by the rotation of the rotary brush serving as the cleaning working unit 11 can be sucked by the suction unit 16.

In the present embodiment, the suction unit 16 executes negative pressure suction in conjunction with the operating state of the cleaning working unit 11, but may be driven independently of the state of the cleaning working unit 11 as another embodiment. The suction unit 16 includes a fan 161 and a filter portion 162, the fan 161 performs negative pressure suction using the power of the electric motor 14, and the air (hereinafter, suction air) generated thereby is taken into the sweeper 1 via the filter portion 162. The filter portion 162 filters particles in the suction air, thereby holding foreign matter generated by the cleaning work and sucked in the sweeper 1.

The air guiding mechanism 17 is a guide member that guides the suction air taken into the sweeper 1, and can be fixed to the chassis or the main frame of the sweeper 1. The air guiding mechanism 17 includes a suction port 171, an exhaust port 172, and an air guide passage 173. The suction port 171 is an opening for taking suction air by the suction unit 16 into the sweeper 1. The exhaust port 172 is an opening for discharging the suction air to the outside of the sweeper 1. The air guide passage 173 connects the suction port 171 and the exhaust port 172 to form a flow path of suction air.

The user can attach or detach the battery unit B to or from the battery holder H at a desired timing, and can replace the battery unit B with a new battery unit B when the remaining amount of the battery unit B becomes equal to or less than the reference. Here, for easy understanding, the battery holder H holds a single battery unit B, but may be capable of holding a plurality of battery units B as illustrated in another embodiment to be described later.

With such a configuration, the user can get on the sweeper 1, cause the sweeper 1 to travel while performing operation input to the operation input unit 13, and perform cleaning work. Such a boarding sweeper 1 may be referred to as a road surface cleaning machine, a floor cleaning machine, or simply a cleaning machine, or may be referred to as a working machine from other viewpoints.

Incidentally, the weight of the battery unit B is generally relatively large, and several to several tens of [kg (kilograms)] for the battery unit B can be used in order to sufficiently operate the sweeper 1 of the present configuration. Here, in a case where the center of gravity is not balanced, in general, the traveling stability of the sweeper 1 is impaired, and accordingly, the load of the cleaning working unit 11 is unnecessarily increased, and as a result, there is a possibility that the efficiency of the cleaning work is reduced. Therefore, in the sweeper 1 that includes the battery unit B having a relatively large weight and is a three-wheeled vehicle in the present embodiment, it is required to appropriately balance the center of gravity of the sweeper 1.

As illustrated in FIG. 2A, a region on the left lateral side with respect to a virtual line L1 passing through in the X direction in the sweeper 1 is defined as a region RL, and a region on the right lateral side is defined as a region RR. At this time, in the example of FIG. 2A, the cleaning working unit 11, the seat portion 12, and the operation input unit 13 are disposed in the region RR, and the battery holder H is disposed in the region RL. As another example, the cleaning working unit 11, the seat portion 12, and the operation input unit 13 may be disposed in the region RL, and the battery holder H may be disposed in the region RR.

According to the vehicle body structure described above, it is possible to operate and drive the sweeper 1 while keeping the balance of the center of gravity of the sweeper 1, and thus, it is possible to appropriately perform the cleaning work without unnecessarily increasing the load of the cleaning working unit 11. Therefore, according to the present embodiment, it is possible to improve the efficiency of the cleaning work.

As a reference example, in a case where the seat portion 12 on which the user rides, the battery holder H holding the battery unit B having a relatively large weight, and the like are collectively arranged at the center in the Y direction of the sweeper 1, the vehicle body length (length in the X direction) and/or the vehicle body height (length in the Z direction) can be increased. In addition, it is required to increase the vehicle width (length in the Y direction) in order to stabilize the traveling of the sweeper 1, and as a result, the vehicle body may be unnecessarily enlarged.

On the other hand, according to the above-described vehicle body structure, it is possible to prevent an unnecessary increase in size of the vehicle body. Furthermore, since the user riding on the seat portion 12 is positioned on the substantially straight line in the X direction of the cleaning working unit 11, it is easy to visually recognize the route through which the user should pass when executing the cleaning work, and thus, it can be advantageous for further improving the efficiency of the cleaning work.

When viewed in the Y direction (in side view), the battery holder H is preferably disposed at a position overlapping the range from the operation input unit 13 to the seat portion 12. This makes it possible to deflect the center of gravity of the sweeper 1 toward the front side of the vehicle body while balancing the right and left of the center of gravity of the sweeper 1, to stabilize the travel of the sweeper 1, and to further stabilize the cleaning work accordingly. In addition, the battery holder H may be configured to enable insertion and removal of the battery unit B in the vehicle body vertical direction, so that the user can attach or detach the battery unit B at the seat portion 12.

In a plan view (see FIG. 2A), the virtual line L1 is set at a position shifted from the front wheel WF in the present embodiment, but may be set at a position on the front wheel WF as another embodiment.

According to the present embodiment, the cleaning working unit 11, the seat portion 12, and the operation input unit 13 are arranged in the region RR (or the region RL) on one lateral side, and the battery holder H is arranged in the region RL (or the region RR) on the other lateral side. This makes it possible to operate and drive the sweeper 1 while balancing the center of gravity of the sweeper 1, to stabilize the travel of the sweeper 1, and to appropriately perform the cleaning work without unnecessarily increasing the load of the cleaning working unit 11. Therefore, according to the present embodiment, it is possible to improve the efficiency of the cleaning work.

### Second Embodiment

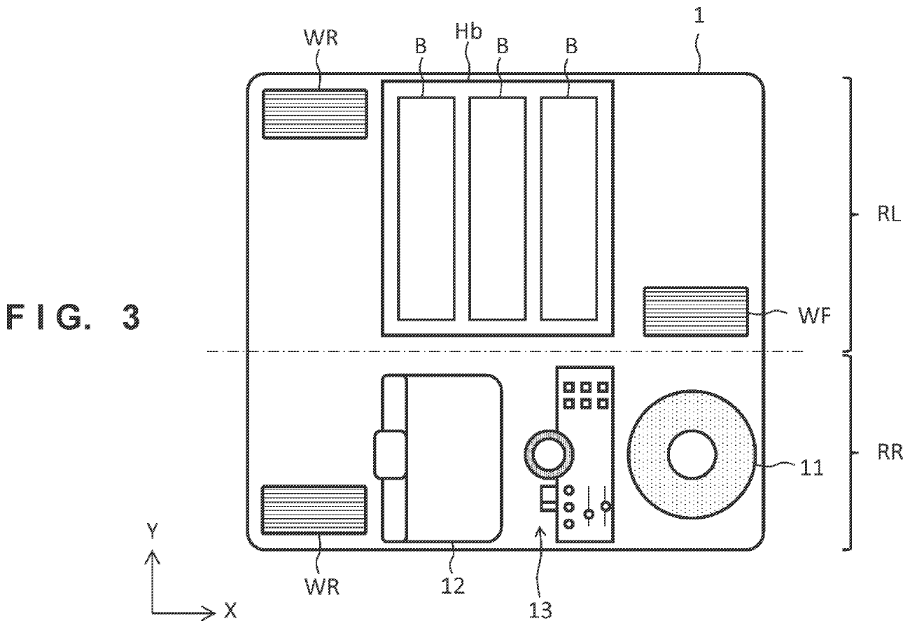

FIG. 3 illustrates a configuration example of the sweeper 1 according to a second embodiment. In the present embodiment, the sweeper 1 includes a battery holder Hb configured to be able to hold a plurality of battery units B, and the plurality of battery units B can be individually inserted and removed.

Incidentally, it is also possible to adjust the number of battery units B actually held by the battery holder Hb for the purpose of further improving the balance of the center of gravity of the sweeper 1. That is, when the total number of battery units B that can be held by the battery holder Hb is N, the battery holder Hb only needs to hold K (any integer of 1 to N) battery units B, and the user can select the holding position.

In the example of FIG. 3, the battery holder Hb is configured such that the plurality of battery units B are arranged in the X direction, but as another example, the battery holder Hb may be configured such that the plurality of battery units B are arranged in the Y direction. As still another example, the battery holder Hb may be configured such that the plurality of battery units B are arranged in an oblique direction (any direction on the X-Y plane), or, incidentally, may be configured such that the individual battery units B are held at different heights from each other. According to any of these aspects, the center of gravity of the sweeper 1 can be appropriately balanced.

Furthermore, according to the present embodiment, for example, in a case where the vehicle body structure of the sweeper 1 is changed, the battery holder Hb can be designed so that the total number of battery units B that can be held increases. This can also be considered to enable the design of the sweeper 1 of various sizes.

### Third Embodiment

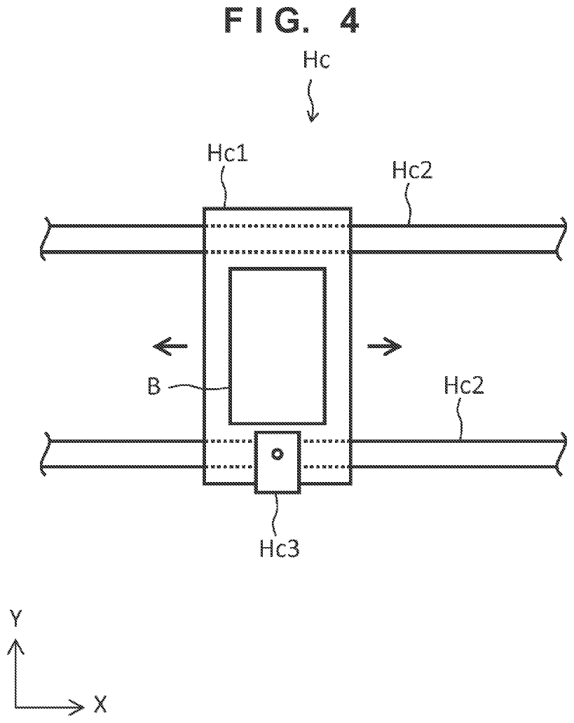

FIG. 4 illustrates a configuration example of a battery holder Hc according to a third embodiment. The battery holder Hc includes a frame Hc1, a rail Hc2, and a lock mechanism Hc3, and can hold a single battery unit B in the present embodiment. The frame Hc1 is a frame member for fixing the battery unit B, and is configured such that the battery unit B can be inserted and removed, whereby electrical connection is realized such that electric power of the battery unit B can be used when the battery unit B is attached. When the battery unit B is removed from the frame Hc1, the electrical connection can be released.

The rail Hc2 is fixed to the vehicle body of the sweeper 1 and is configured to be slidable on the frame Hc1, and in the present embodiment, the frame Hc1 is slidable in the X direction. In addition, the lock mechanism Hc3 is configured to be able to engage a position of the frame Hc1 slidable with respect to the rail Hc2 and to be able to release the engagement, that is, can adjust the relative position of the frame Hc1 with respect to the rail Hc2. Note that the electrical connection and the release of the battery unit B may be realized by engaging and releasing by the lock mechanism Hc3, respectively.

According to such a configuration, the battery holder Hc can adjust the holding position itself of the battery unit B, thereby making it possible to balance the center of gravity of the sweeper 1.

In the example of FIG. 4, the battery holder Hc is configured to be able to adjust the holding position of the battery unit B in the X direction. However, as another example, the battery holder Hc may be configured to be able to adjust the holding position of the battery unit B in the Y direction. As still another example, the battery holder Hc may be configured to be capable of adjusting the holding position of the battery unit B in an oblique direction (any direction on the X-Y plane), or may be configured to be capable of incidentally adjusting the holding position of the battery unit B in the Z direction. According to any of these aspects, the center of gravity of the sweeper 1 can be appropriately balanced.

The number of battery units B that can be held by the battery holder Hc may be two or more, and in that case, the holding positions of the two or more battery units B may be individually adjustable. At that time, in combination with the above-described second embodiment, the battery holder Hb itself may be configured to be able to change the arrangement direction of the plurality of battery units B. For example, each of the plurality of sub-holders that directly hold the plurality of battery units B may be movably supported in the battery holder Hb.

In the above description, to facilitate understanding, each element is indicated by a name related to its functional aspect, but each element is not limited to an element that has the content described in the embodiment as a main function, and may be element that has supplementary content. Therefore, each element is not strictly limited to the expression, and such an expression can be replaced with a similar expression. For the same purpose, the expression “apparatus” may be replaced with “unit”, “component”, “piece”, “member”, “structure”, “assembly”, or the like, or may be omitted.

### Summary of Embodiments

Some features of the above embodiments will be summarized as follows:
A first aspect provides a boarding sweeper (1), comprising:
a cleaning working unit (11) capable of executing cleaning work;
a seat portion (12) for seating a user;
an operation input unit (13) that allows the user to input a driving operation; and
a battery holder (H) that detachably holds a battery unit (B), wherein,
when an area on one lateral side with respect to a virtual line (L1) passing through in a front-and-rear direction of a vehicle body in plan view is defined as a first area (one of RL and RR) and an area on the other lateral side is defined as a second area (the other of RL and RR), the cleaning working unit, the seat portion, and the operation input unit are disposed in the first area, and the battery holder is disposed in the second area.

As a result, the sweeper can be operated and driven while balancing the center of gravity of the sweeper, whereby the cleaning work can be appropriately performed without unnecessarily increasing the load of the cleaning working unit. Therefore, according to the first aspect, it is possible to improve the efficiency of the cleaning work.

In a second aspect,
the cleaning working unit includes a rotary brush (11) having a rotation axis in a vertical direction of a vehicle body.
Accordingly, the cleaning work is appropriately achievable.

In a third aspect,
the sweeper further comprises:
a pair of left and right rear wheels (WR) and a single front wheel (WF), wherein
the cleaning working unit is disposed on the one lateral side with respect to the front wheel.
Accordingly, the above first aspect is appropriately achievable.

In a fourth aspect,
the operation input unit is a steering mechanism (13c) having the front wheel as a steering wheel.
As a result, the first aspect can be appropriately realized, and the steering mechanism can have a relatively simple configuration.

In a fifth aspect,
the battery holder is disposed at a position overlapping a range from the operation input unit to the seat portion in a side view.
This makes it possible to deflect the center of gravity toward the front side of the vehicle body, thereby stabilizing the cleaning work.

In a sixth aspect,
the battery holder is configured to be able to insert and remove the battery unit in a vertical direction of a vehicle body.
Accordingly, attachment or detachment of the battery unit can be realized relatively easily.

In a seventh aspect,
the battery unit is one of a plurality of battery units, and
the battery holder is configured to be able to hold the plurality of battery units.

This makes it possible to design sweepers of various sizes and, at the same time, to arbitrarily adjust the quantity of battery units, thereby making it easier to balance the center of gravity of the sweeper.

In an eighth aspect,
the battery holder is configured such that the plurality of battery units are arranged in the front-and-rear direction of the vehicle body.
This makes it easier to balance the center of gravity of the sweeper.

In a ninth aspect,
the battery holder is configured such that the plurality of battery units are arranged in a lateral direction of the vehicle body.
This makes it easier to balance the center of gravity of the sweeper.

The invention is not limited to the foregoing embodiments, and various variations/changes are possible within the spirit of the invention.

What is claimed is:

1. A boarding sweeper comprising:
a cleaning working unit capable of executing cleaning work;
a seat portion for seating a user;
an operation input unit that allows the user to input a driving operation; and
a battery holder that detachably holds a battery unit, wherein,
when an area on one lateral side with respect to a virtual line passing through in a front-and-rear direction of a vehicle body in plan view is defined as a first area and an area on the other lateral side is defined as a second area, the cleaning working unit, the seat portion, and the operation input unit are disposed in the first area, and the battery holder is disposed in the second area.

2. The sweeper according to claim 1, wherein
the cleaning working unit includes a rotary brush having a rotation axis in a vertical direction of a vehicle body.

3. The sweeper according to claim 1, further comprising:
a pair of left and right rear wheels and a single front wheel, wherein
the cleaning working unit is disposed on the one lateral side with respect to the front wheel.

4. The sweeper according to claim 3, wherein
the operation input unit is a steering mechanism having the front wheel as a steering wheel.

5. The sweeper according to claim 1, wherein
the battery holder is disposed at a position overlapping a range from the operation input unit to the seat portion in a side view.

6. The sweeper according to claim 1, wherein
the battery holder is configured to be able to insert and remove the battery unit in a vertical direction of a vehicle body.

7. The sweeper according to claim 6, wherein
the battery unit is one of a plurality of battery units, and
the battery holder is configured to be able to hold the plurality of battery units.

8. The sweeper according to claim 7, wherein
the battery holder is configured such that the plurality of battery units are arranged in the front-and-rear direction of the vehicle body.

9. The sweeper according to claim 7, wherein
the battery holder is configured such that the plurality of battery units are arranged in a lateral direction of the vehicle body.
